(19) United States
(12) Patent Application Publication
(10) Pub. No.: US 2026/0112297 A1
(43) Pub. Date: Apr. 23, 2026

(54) VEHICLE AND DRIVING METHOD THEREOF

(71) Applicant: InnoLux Corporation, Miao-Li County (TW)

(72) Inventors: Chia-Hsien HSIEH, Miao-Li County (TW); Chen-Li YEH, Miao-Li County (TW); Hong-Sheng HSIEH, Miao-Li County (TW); Hsuan-Ting KUO, Miao-Li County (TW)

(73) Assignee: InnoLux Corporation, Miao-Li County (TW)

(21) Appl. No.: 19/324,110

(22) Filed: Sep. 10, 2025

Related U.S. Application Data
(60) Provisional application No. 63/710,038, filed on Oct. 22, 2024.

(30) Foreign Application Priority Data
Jun. 12, 2025 (CN) 202510781770.2

(51) Int. Cl. G09G 3/00; G02B 3/00; G02B 27/01; G06F 3/01

(52) U.S. Cl. CPC G09G 3/003; G02B 3/005; G02B 27/0101; G06F 3/013; G09G 2354/00; G09G 2380/10

(57) ABSTRACT

A vehicle and a driving method thereof are provided. The vehicle is configured to provide a first image and a second image with a projection distance respectively to a first position and a second position. The vehicle includes a windshield and a display device. The display device is configured to generate a plurality of first light beams and a plurality of second light beams to be projected on a side of the windshield and to present the first image and the second image on another side of the windshield.

### CROSS REFERENCE TO RELATED APPLICATION

This application claims the benefit of U.S. Provisional Application No. 63/710,038, filed on Oct. 22, 2024. The content of the application is incorporated herein by reference.

### BACKGROUND OF THE DISCLOSURE

### 1. Field of the Disclosure

The present disclosure relates to a vehicle and a driving method thereof and particularly to a vehicle capable of presenting augment reality image and a driving method thereof.

### 2. Description of the Prior Art

With development of technology, conventional dashboards and lights in vehicles have gradually been replaced by various electronic display devices. In conventional vehicles, head-up displays (HUDs) have been developed to project dashboard information onto the windshield, allowing drivers to view the dashboard information through an image reflected by the windshield and at the same time view the scenery outside the vehicles. However, the conventional head-up displays project images through lenses, so that a sufficiently long optical path and a sufficiently large space are required. In addition, the conventional head-up displays cannot display images with depth of field, which limits contents of the displayed information. Although conventional three-dimensional display devices may present three-dimensional images with depth of field, depths of focus in left and right eye images presented by the three-dimensional display devices are easily mismatched with parallax of left and right eyes, causing discomfort to the drivers and/or affecting safety.

### SUMMARY OF THE DISCLOSURE

One of objectives of the present disclosure is to provide a vehicle and a driving method thereof to present an image with depth of field or improve comfort to a user or safety of the vehicle.

An embodiment of the present disclosure provides a vehicle configured to provide a first image and a second image with a projection distance respectively to a first position and a second position. The vehicle includes a windshield and a display device. The display device is configured to generate a plurality of first light beams and a plurality of second light beams to be projected on a side of the windshield and to present the first image and the second image on another side of the windshield. The display device includes a display and a lens structure. The display includes a plurality of first sub-pixels and a plurality of second sub-pixels. The lens structure is disposed on the display and has an exit angle difference, wherein light generated by the first sub-pixels penetrates through the lens structure to form the first light beams, the first light beams form the first image, light generated by the second sub-pixels penetrates through the lens structure to form the second light beams, and the second light beams form the second image. An angle is between a connection line of a pixel point in the first image and the first position and another connection line of the pixel point in the first image and the second position, and the angle satisfies a first relation:

$${tan}^{- 1} ( \frac{6}{P D + 15} ) \leq θ \leq {tan}^{- 1} ( \frac{7}{P D - 15} ) ,$$

wherein θ is the angle, PD is the projection distance, and a unit of PD is centimeter. The angle satisfies a second relation:

$$θ \neq N \times θ f ,$$

wherein θf is the exit angle difference, and N is a positive integer.

Another embodiment of the present disclosure provides a driving method of a vehicle. The vehicle includes a display device, an eye tracker, a computing unit, and a processing unit. The driving method includes obtaining a first position information and a second position information by the eye tracer, wherein the first position information and the second position information respectively include a left eye coordinate and a right eye coordinate of a user; generating a first image information and a second image information according to the first position information and the second position information by the computing unit, wherein the first image information corresponds to the first position information, and the second image information corresponds to the second position information; generating a display signal according to the first image information, the second image information, the first position information, and the second position information by the computing unit; and providing a first image and a second image with a projection distance respectively to a first position and a second position according to the display signal by the display device.

In the vehicle of the present disclosure, the angle satisfying the first relation may be obtained through the given projection distance or the projection distance measured by the eye tracker, such that the first image and the second image displayed by the display device are respectively viewed by different eyes, thereby improving the comfort of the user or improving the driving safety. In addition, the display device formed by the above relations does not require the complex and long optical path, so that the space in the vehicle for accommodating the display device may be reduced.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a side view of a vehicle according to a first embodiment of the present disclosure.

FIG. 2 schematically illustrates a cross-sectional view of the display device according to the first embodiment of the present disclosure.

FIG. 3 schematically illustrates a top view of the display device according to an embodiment of the present disclosure.

FIG. 4 schematically illustrates the light generated by the sub-pixel forming parallel light beams in the display device of the present disclosure.

FIG. 5 schematically illustrates a top view of the user viewing the image.

FIG. 6 schematically illustrates a cross-sectional view of a display device according to a variant embodiment of the first embodiment of the present disclosure.

FIG. 7 schematically illustrates a cross-sectional view of a vehicle according to a second embodiment of the present disclosure.

FIG. 8 schematically illustrates a block diagram of a system of a vehicle according to a third embodiment of the present disclosure.

FIG. 9 schematically illustrates a driving method of the vehicle according to the third embodiment of the present disclosure.

### DETAILED DESCRIPTION

The contents of the present disclosure will be described in detail with reference to specific embodiments and drawings. It is noted that, for purposes of illustrative clarity and ease of understanding by the readers, the following drawings in the present disclosure may be a simplified illustrations, and elements therein may not be drawn to scale. The numbers and sizes of the elements in the drawings are merely illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not in function.

In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. This does not mean that the element has any previous ordinal numbers, nor does this represent the order of a certain element and another element, or the sequence in a manufacturing method. These ordinal numbers are merely used to make a claimed element with a certain name be clearly distinguishable from another claimed element with the same name.

Spatially relative terms, such as “above”, “on”, “below”, “under”, “left”, “right”, “front”, “behind” and the like, used in the following embodiments only refer to the directions in the drawings and are not intended to limit the present disclosure.

In addition, when one element or layer is “on” another element or layer, it may be understood that the element or layer is directly on the another element or layer, and alternatively, there is another element or layer between the two elements or layers (indirectly). On the contrary, when the element or layer is “directly on” another element or layer, it may be understood that there is no other element or layer between them.

The term “connect” may include means of “directly connect” or “indirectly connect”. Two elements electrically connected to each other may refer to the elements in direct contact with each other to transmit electrical signals with no other elements between them, or the elements bridged by an element between them to transmit the electrical signals. Besides, the term “electrically connect” may be called “couple”.

As disclosed herein, the terms “approximately”, “essentially”, “about”, or “substantially” generally mean within 10%, 5%, 3%, 2%, 1%, or 0.5% of the reported numerical value or range.

It should be understood that, according to the following embodiments, features of different embodiments may be replaced, recombined or mixed to constitute other embodiments without departing from the spirit of the present disclosure. The features of various embodiments may be mixed arbitrarily and used in different embodiments without departing from or conflicting with the spirit of the present disclosure.

In the present disclosure, length, thickness, width, height, distance, and area may be measured by using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

A vehicle of the present disclosure may, for example, include a display device, a sensing device, an antenna device, a touch device, a tiled device, or other suitable electronic devices, but not limited thereto. The electronic device may, for example, be a bendable, stretchable, foldable, rollable, and/or flexible electronic device, but not limited thereto. The display device may, for example, be a tiled display, a car display, a touch display, a transparent display, a dual sided display, a virtual reality (VR) display, an augmented reality (AR) display, a 3D display, a monochrome display, a color display, etc., but not limited thereto. The display device may, for example, include liquid crystal molecules, organic light emitting diodes (OLEDs), inorganic light emitting diodes (LEDs), mini light emitting diodes (mini LEDs), micro light emitting diode (micro LEDs), or quantum dot light emitting diodes (e.g., QLEDs/QDLEDs), electro-phoretic, fluorescent material, phosphor material, other suitable display media, or a combination of the aforementioned display media, but not limited thereto. The sensing device may, for example, be a sensing device used for detecting variation in capacitances, light, heat, or ultrasound, but not limited thereto. The sensing device may, for example, include a bio-sensor, a touch sensor, a fingerprint sensor, other suitable sensors, or any combination of the aforementioned sensors. The antenna device may include liquid crystal antenna, varactor diode antenna, or antennas of other types, but not limited thereto. The tiled device may, for example, include a tiled display device or a tiled antenna device, but not limited thereto. Furthermore, the appearance of the electronic device may be, for example, rectangular, circular, polygonal, a shape with curved edges, curved or other suitable shapes. The electronic device may have peripheral systems, such as a driving system, a control system, a light source system, a shelf system, etc. The electronic device may include electronic units, in which the electronic units may include a passive element and an active element, and for example, include a capacitor, a resistor, an inductor, a diode, a transistor, a sensor, etc. It is noted that the electronic device of the present disclosure may be any combination of the above-mentioned devices, but not limited thereto.

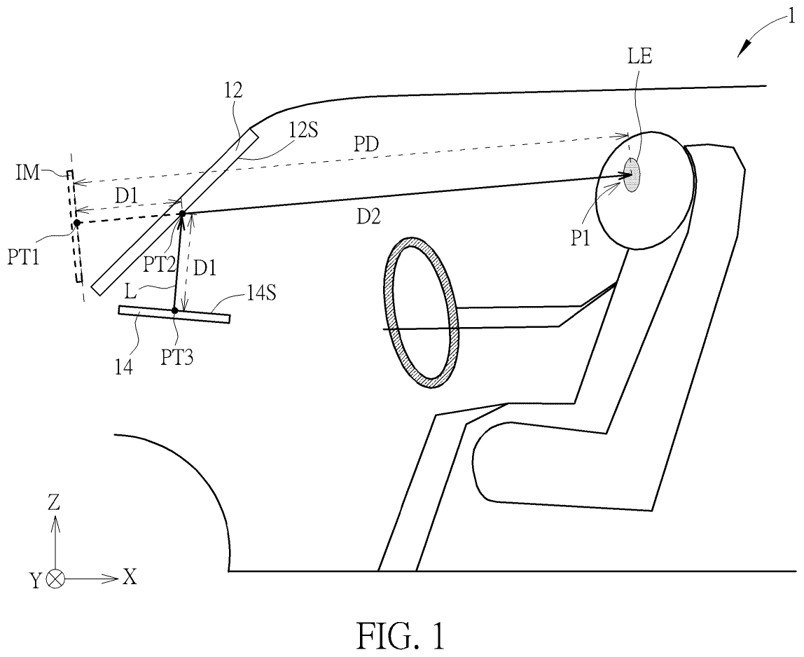

Refer to FIG. 1, which schematically illustrates a side view of a vehicle according to a first embodiment of the present disclosure. The vehicle 1 includes a windshield 12 and a display device 14, wherein the display device 14 may be configured to generate a plurality of light beams L projected on a side of the windshield 12 and reflected to two positions through the windshield 12, and an image IM is presented on another side of the windshield 12. The vehicle 1 of the present disclosure may be, for example, a car, an airplane, a train or other suitable means of transportation. In the embodiment of FIG. 1, the car is taken as an example of the vehicle 1, and a driver is taken as an example of a user, but not limited thereto. When eyes of the user are respectively located at the two positions, the eyes may view the virtual image IM through the windshield 12. In FIG. 1, the left eye LE is taken as an example, but not limited thereto. The image IM may be matched or combined with the scenery outside the vehicle 1 to form an AR image, but not limited thereto. The display device 14 may be, for example, an augmented reality head-up display (AR HUD) or applied to any suitable vehicle device, but not limited thereto. The windshield 12 may be, for example, a wedge type, a flat type, a curve type, or a combination thereof, but not limited thereto. The windshield 12 may optionally further have a film thereon, but not limited thereto.

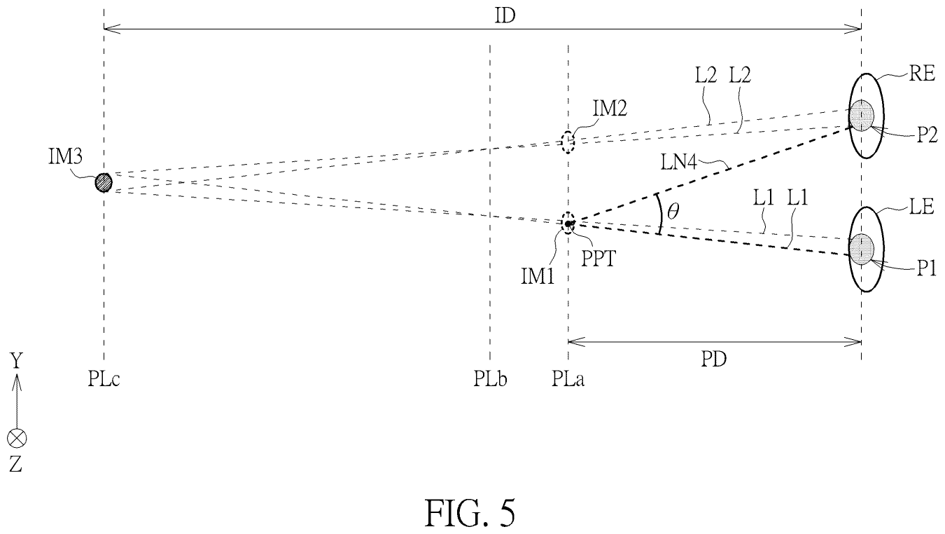

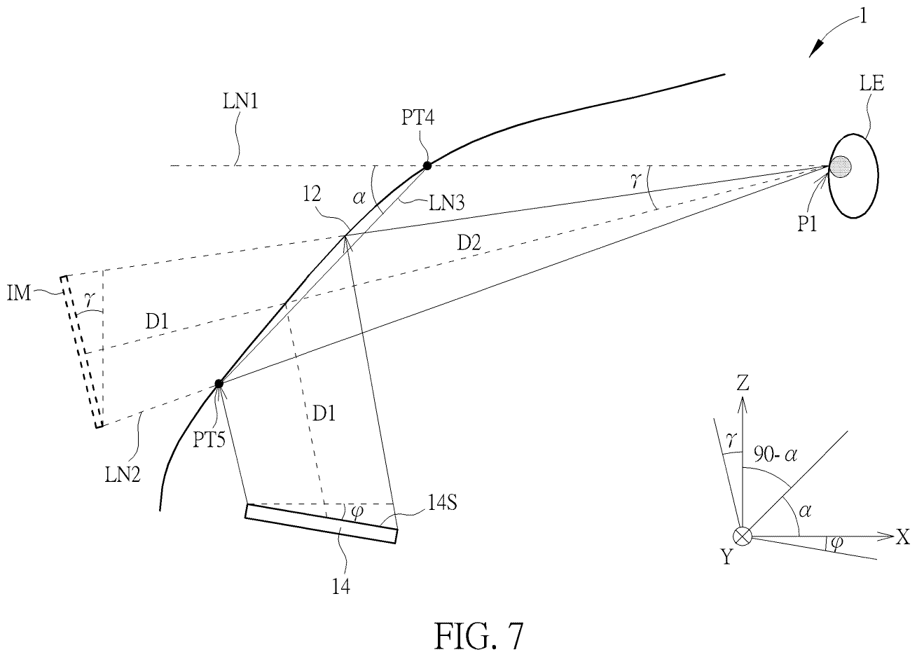

FIG. 1 illustrates a direction X, a direction Y, and a direction Z. As shown in FIG. 1, the direction X and the direction Z may be a horizontal direction of the vehicle 1 and may be perpendicular to the direction Z. A direction reverse to the direction X may be a direction in which the vehicle 1 moves forward, and the direction Y may be an arrangement direction of two eyes. The following contents relating to FIG. 1, FIG. 5 and FIG. 7 may describe the spatial relations of the vehicle 1 based on the direction X, the direction Y, and the direction Z.

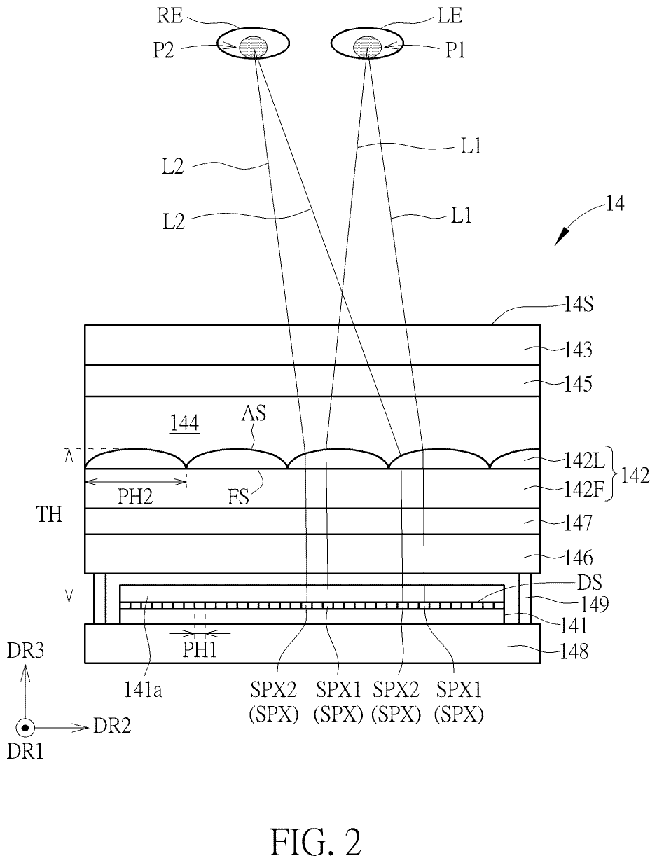

Further refer to FIG. 2 together with FIG. 1. FIG. 2 schematically illustrates a cross-sectional view of the display device according to the first embodiment of the present disclosure. As shown in FIG. 1 and FIG. 2, the display device 14 may include a display 141 and a lens structure 142, wherein the lens structure 142 is disposed on the display 141, so that the display device 14 may generate a plurality of first light beams L1 and a plurality of second light beams L2 projected on a side of the windshield 12 and reflected to a first position P1 and a second position P2 by the windshield 12. Accordingly, a first image and a second image are presented on another side of the windshield 12 by the display device 14. In other words, the light beams L may include a plurality of first light beams L1 and a plurality of second light beams L2, and the first image and the second image may form the image IM.

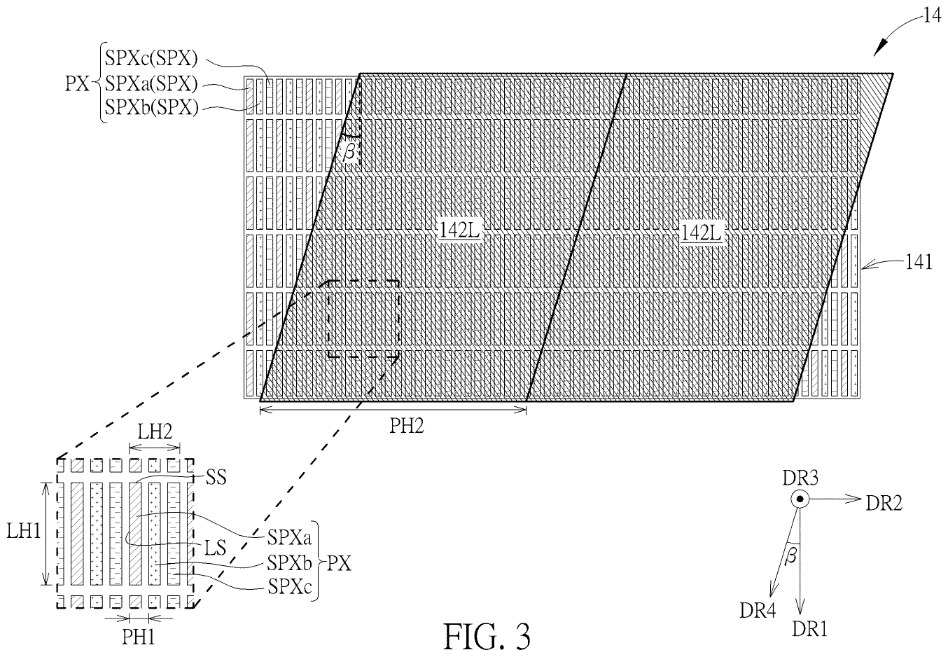

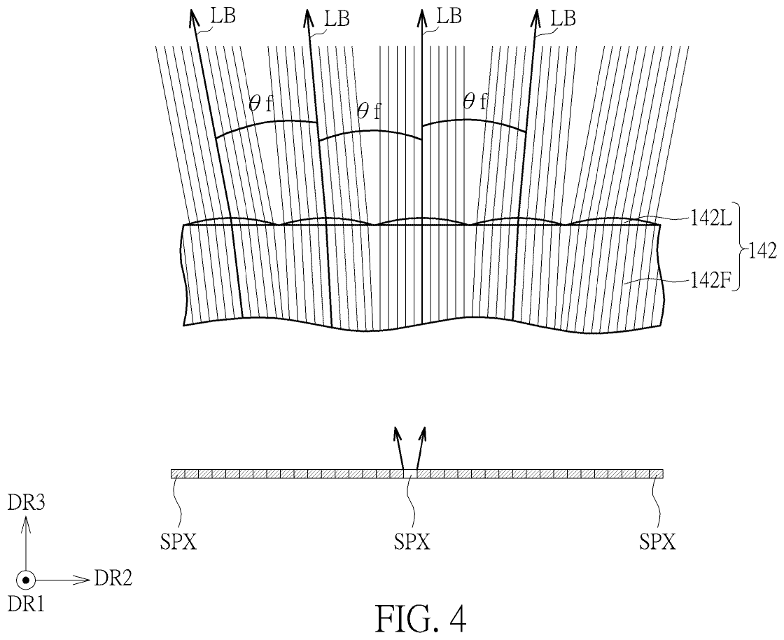

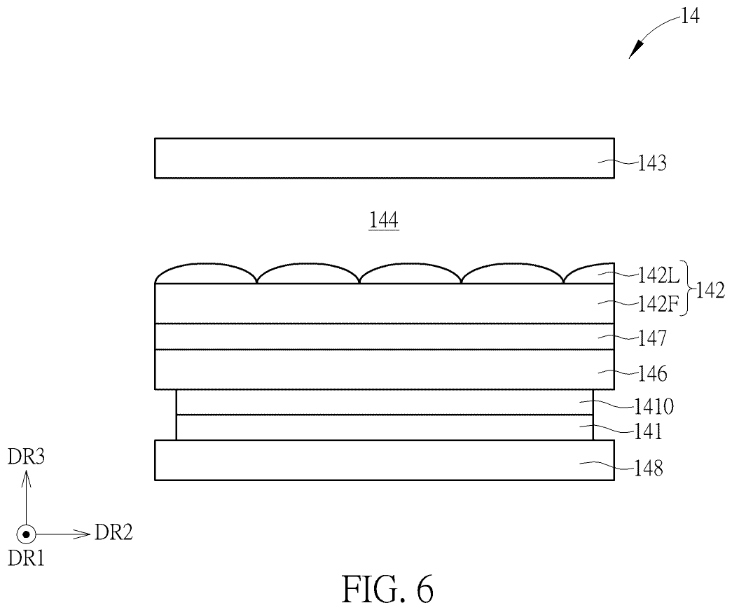

Since a light exiting surface 14S of the display device 14 may be parallel or non-parallel to the horizontal direction of the vehicle 1, the direction DR1, the direction DR2, and the direction DR3 are illustrated in FIG. 2. As shown in FIG. 2, the direction DR3 is a normal direction of the light exiting surface 14S and is perpendicular to the light exiting surface 14S. The direction DR1 and the direction DR2 may be perpendicular to the direction DR3. Following contents relating to FIG. 2, FIG. 3, FIG. 4, and FIG. 6 may describe the spatial relationship of the display device 14 according to the direction DR1, the direction DR2, and the direction DR3. In FIG. 2, the direction DR2 may be, for example, the same as the direction Y in FIG. 1, but not limited thereto.

Specifically, the display 141 may include a plurality of sub-pixels SPX, wherein the sub-pixels SPX may include a plurality of first sub-pixels SPX1 and a plurality of second sub-pixels SPX2. Light generated by the first sub-pixels SPX1 may penetrate through the lens structure 142 to form the first light beams L1, and the first light beams L1 may form a first image and be reflected to the first position P1 by the windshield 12. Light generated by the second sub-pixels SPX2 may penetrate through the lens structure 142 to form a second light beams L2, and the second light beams L2 may form a second image and be reflected to the second position P2 by the windshield 12. In other words, the vehicle 1 may provide the first image and the second image with a projection distance PD respectively to the first position P1 and the second position P2. When the left eye LE and the right eye RE of the user are respectively located at the first position P1 and the second position P2, both eyes may view the first image and the second image, respectively, wherein there may be an offset between the first image and the second image in the arrangement direction of the left eye LE and the right eye RE (e.g., the direction Y), so that the image IM finally viewed by the user is a three-dimensional image or an image with depth of field, but not limited thereto. A distance between the first position P1 and the second position P2 may be, for example, an interpupillary distance (IPD), such as 6 cm to 7 cm. The first image and the second image may each be a light beam generated by a corresponding sub-pixel SPX or a combination of light beams generated by a plurality of the sub-pixels SPX.

As shown in FIG. 1, taking the left eye LE as an example, the projection distance PD may be the shortest distance between the left eye LE (or the first position P1) of the user and the first image (e.g., image IM), but not limited thereto. The projection distance PD may also be the shortest distance between the right eye RE of the user and the second image. When a distance from the left eye LE to a point PT1 is the shortest distance from the left eye LE of the user to the image IM, a distance from the point PT1 to the left eye LE is the projection distance PD, wherein a distance from an intersection point PT2 of a line connecting the point PT1 and the left eye LE and a surface 12S of the windshield 12 to the point PT1 may be the distance D1, and a distance from the intersection point PT2 to the left eye LE is the distance D2. In other words, the projection distance PD is the sum of the distance D1 and the distance D2. Since the image IM viewed by the user is formed by the light beams L of the display device 14 being reflected by the windshield 12, the distance from a point (e.g., the point PT1) in the image IM viewed by the user to the surface 12S of the windshield 12 is the same as the distance from a corresponding point (e.g., a point PT3) on the light exiting surface 14S of the display device 14 to the surface 12S of the windshield 12, wherein light generated by the corresponding point on the light exiting surface 14S is used to form the point in the image IM. In other words, the distance from the intersection point PT2 to the point PT3 is the distance D1.

The projection distance PD may be obtained through measurement. For example, as shown in FIG. 1 and FIG. 2, the measuring method of the projection distance PD may include turning on one of the sub-pixels SPX in the display device 14 and turning off other sub-pixels SPX; disposing a camera or other devices capable of measuring a focus distance at the first position P1 or the second position P2; adjusting magnification factor of the camera to make the camera obtain a clear and sharp image; and obtaining the focus distance of the camera, wherein the focus distance is the projection distance PD. In other words, the projection distance PD may be defined, for example, by the focal distance of the camera located at the first position P1 (or the second position P2) when focusing on a pixel point corresponding to one of the light beams of the sub-pixels SPX in the first image (or the second image). In some embodiments, when the display device 14 is unable to turn on only one of the sub-pixels SPX, the measuring method may include placing a piece of paper with a mark on the light exiting surface 14S of the display device 14, and adjusting the magnification factor of the camera to make the camera obtain a clear and sharp mark image. The obtained focus distance of the camera is the projection distance PD. The projection distance PD of this embodiment may be exemplified by a certain value, but not limited thereto.

The lens structure 142 may include a plurality of lenses 142L arranged on the display 141. Shapes of the lenses 142L may be altered according to different optical requirements, but not limited thereto. The light generated by each first sub-pixel SPX1 may be refracted by the lenses 142L and focused on the first position P1, so that the left eye LE at the first position P1 may view the first image. The light generated by the second sub-pixel SPX2 may be refracted by the lenses 142L and focused on the second position P2, so that the right eye RE at the second position P2 may view the second image. For example, each lens 142L may be a plano-convex lens with a curved surface AS and a flat surface FS opposite to the curved surface AS, wherein the flat surface FS faces the display 141, and the curved surface AS is away from the display 141. The lenses 142L may include, for example, glass or other suitable materials.

Refer to FIG. 3, which schematically illustrates a top view of the display device according to an embodiment of the present disclosure. In one embodiment, the sub-pixels SPX of the display 141 may be arranged in an array, for example, but not limited thereto. In FIG. 3, the sub-pixels SPX may include a plurality of sub-pixels SPXa, a plurality of sub-pixels SPXb, and a plurality of sub-pixels SPXc configured to generate different colors of light, such as red, green, and blue light, or other combinations of suitable colors of light. For example, one of the sub-pixels SPXa, one of the sub-pixels SPXb, and one of the sub-pixels SPXc form a pixel PX, but not limited thereto. In the same row of the array, the sub-pixels SPXa, the sub-pixels SPXb, and the sub-pixels SPXc may be arranged alternately, and the sub-pixels SPX in the same column may all be the sub-pixels generating the same color of light, but not limited thereto. It should be noted that according to the relative relationship between the sub-pixels SPX and the lenses 142L, a part of the sub-pixels SPXa, the sub-pixels SPXb, and the sub-pixels SPXc may be used as the first sub-pixels SPX1 in FIG. 2 to display the first image, and another part of them may be used as the second sub-pixels SPX2 in FIG. 2 to display the second image. In some embodiments, arrangement of the sub-pixels is not limited to that shown in FIG. 3 and may be other suitable arrangements.

It is worth mentioning that the lenses 142L may be extended along a direction DR4, and the direction DR4 may be different from a column direction (e.g., the direction DR1) and the row direction (e.g., the direction DR2) of the array, so that Moiré pattern in the image generated by the display device 14 may be reduced. In this embodiment, each lens 142L may be, for example, a lenticular lens, but not limited thereto. As shown in an enlarged diagram on lower left side of FIG. 3, one of the sub-pixels SPX has a long side LS, and an angle β between an extending direction of the long side LS (e.g., direction DR1) and direction DR4 may be, for example, in a range from 2 degrees to 20 degrees, thereby reducing the Moiré pattern.

As shown in FIG. 2 and FIG. 3, the sub-pixels SPX has a first pitch PH1 in the row direction of the array, that is, a first pitch PH1 is between left sides, right sides or two corresponding points of two adjacent sub-pixels SPX in the same row of the sub-pixels SPX. Moreover, the lenses 142L have a second pitch PH2 in the row direction (e.g., the direction DR2). The first pitch PH1 of the sub-pixels SPX and the second pitch PH2 of the lenses 142L may be used to determine a sub-pixel angular resolution, which is detailed below.

In the embodiment of FIG. 3, the sub-pixel SPX may further have a short side SS adjacent to the long side LS, wherein an extending direction of the short side SS corresponds to the horizontal direction of the first image (e.g., the direction DR2), and the extending direction of the long side LS corresponds to the vertical direction of the first image (e.g., the direction DR1). Since the sub-pixel SPXa, the sub-pixel SPXb, and the sub-pixel SPXc in the same row and sequentially arranged constitute the pixel PX, the pixel PX may have a long side equal to the long side LS of the sub-pixel SPX. In addition, a length LH1 of the long side of the pixel PX is greater than a width LH2 of the pixel PX corresponding to the short side SS, that is, a ratio of the length LH1 to the width LH2 may be greater than 1. The width LH2 of the pixel PX corresponding to the short side SS may be the sum of the short sides SS of the sub-pixel SPXa, the sub-pixel SPXb and the sub-pixel SPXc, a distance between the sub-pixel SPXa and the sub-pixel SPXb, and a distance between the sub-pixel SPXb and the sub-pixel SPXc. Since quality of the first image and the second image is affected by the number of the pixels PX in the extending direction of the short side SS and is not affected by the number of the pixels PX in the extending direction of the long side LS, increasing the length LH1 of the long side LS may help reduce the number of the pixels PX in the extending direction of the long side LS in the case that the image quality is not affected. Accordingly, the number of transmission channels of chips for driving the pixels PX may be reduced to save costs. Alternatively, the number of the pixels PX in the extending direction of the short side SS may be increased to improve the image quality. For example, the ratio of the length LH1 to the width LH2 may be in a range from 1.5 to 10, but not limited thereto. In some embodiments, the ratio of the length of the long side LS of the sub-pixel SPX to the width of the short side SS may be in a range from 4.5 to 30, but not limited thereto. In some embodiments, the ratio of the length LH1 to the width LH2 may also be greater than or equal to 1, in other words, the pixel PX may be square, but not limited thereto.

The display 141 may include, but not limited to, light-emitting diodes, liquid crystal molecules, fluorescent material, phosphor material, other suitable display media, or combinations thereof. The light-emitting diode includes, for example, an organic light-emitting diode (OLED), an inorganic light-emitting diode (LEDs), a mini-light-emitting diode (mini-LED), and a micro-light-emitting diode (micro-LED), a quantum dot light-emitting diode (e.g., QLED, QDLED), other suitable materials, or any combination thereof. The display 141 may be bendable or flexible electronic devices. In some embodiments, when the display 141 is a non-self-luminous display, such as an LCD display, the display 141 may include an LCD panel and a backlight module, but not limited thereto.

Refer to FIG. 2 again. The lens structure 142 may further include a substrate 142F to support the lenses 142L. In other words, the flat surfaces FS of the lenses 142L may be directly disposed on the substrate 142F side by side, such that the substrate 142F is located between the lenses 142L and the display 141. The substrate 142F may include, for example, glass, polyethylene terephthalate (PET), polycarbonate (PC), other suitable materials, or a combination thereof. The lens 142L may include, for example, ultraviolet (UV) curing adhesive or other suitable materials. The formation of the lens structure 142 may include, for example, coating the UV curing adhesive on the substrate 142F, and then using a mold with concave columns to imprint and cure the UV curing adhesive, or filling the mold with the concave columns with the UV curing adhesive, and then disposing the substrate 142F on the UV curing adhesive and curing the UV curing adhesive, but not limited thereto.

The display device 14 may further include a cover layer 143 disposed on the lens structure 142 to protect the lens structure 142 or to prevent dust from falling on the lens structure 142. The cover layer 143 may include, for example, glass, quartz, sapphire, ceramic, PC, polyimide (PI), PET, other suitable substrate materials, or a combination thereof. In some embodiments, the cover layer 143 may further have an anti-reflective function, for example, may further include an anti-reflective film, a circular polarizer, a linear polarizer, other suitable optical films, or a combination thereof. The circular polarizer may include, for example, a stack of a half-wave plate and a quarter-wave plate.

The display device 14 may further include an intermediate layer 144 disposed between the lens structure 142 and the cover layer 143, and a refractive index of the intermediate layer 144 may be less than that of the lens 142L. The refractive index of intermediate layer 144 may be, for example, less than or equal to 1.5. In some embodiments, the refractive index of the intermediate layer 144 may be greater than or equal to 1.38 and less than or equal to 1.48, but not limited thereto. In this embodiment, the intermediate layer 144 includes a glue with low refractive index, such as silicone, acrylic resin, tetrafluoroethylene perfluoroalkoxy ether copolymer (PFA), fluorinated ethylene propylene propylene copolymer (FEP), fluoroplastic film (ETFE), ethylene glycol polyether resin (EFEP), polychlorotrifluoroethylene (PCTFE), fluorine resin, silicon compound, fluorine compound, other suitable adhesives or a combination thereof, but not limited thereto. The cover layer 143 may be attached to the intermediate layer 144 by an adhesive layer 145, but not limited thereto. The adhesive layer 145 may include, for example, optical adhesive, other suitable materials, or a combination thereof.

The display device 14 may further include a thickness adjusting layer 146 located between the display 141 and the lens structure 142. By adjusting a thickness of the thickness adjusting layer 146, light exiting surfaces DS of the sub-pixels SPX of the display 141 coincide with equivalent focal plane of the lenses 142L, such that the light generated by each of the first sub-pixels SPX1 and the second sub-pixels SPX2 forms parallel light beams after passing through the lenses 142L. In other words, each first beam L1 and each second beam L2 are respectively parallel light beams emitted along different directions. It should be noted that each lens 142L may have a focal length, which satisfies the following relation:

$$FL = Rc / ( ( nl / ng ) - 1 ) ,$$

where FL is the focal length of the lens 142L, Rc is a radius of curvature of the curved surface AS, nl is the refractive index of the lens 142L, and ng is the refractive index of the intermediate layer 144. When the intermediate layer 144 is air, ng is 1. The radius of curvature of the curved surface AS, the refractive index of the lens 142L, and the refractive index of the intermediate layer 144 may be obtained by measurement. The focal length FL and the second pitch PH2 of the lens 142L may be configured to determine an exit angle difference, which is detailed below.

Since layers between the lens 142L and the display 141 is not made of a single material, that is, there are a plurality of layers between the lens 142L and the display 141, a maximum distance TH between the equivalent focal plane (i.e., the light exiting surface DS of the sub-pixel SPX) and the curved surface AS of the lens 142L may differ from the focal length of the lens 142L. The maximum distance TH may be obtained by measuring or calculating the sum of the ratios of the thicknesses to the refractive indexes of layers between the lens 142L and the light exiting surface DS of the display 141 (or the light exiting surface DS of the sub-pixel SPX of the display 141). For example, when the display 141 is a self-luminous display and takes a light-emitting diode display as an example, the light exiting surface DS of the sub-pixel SPX may be an upper surface of an upper electrode of the light-emitting diode or an upper surface of a light conversion layer on the light-emitting diode. When the display 141 is the non-self-luminous display, the light exiting surface DS of the sub-pixel SPX of the display 141 may be an upper surface of the display medium (e.g., liquid crystal layer), but not limited thereto. The layers between the lens 142L and the light exiting surface DS of the display 141 may include, for example, the substrate 142F, an adhesive layer 147, the thickness adjusting layer 146, and an upper substrate 141a of the display 141. When the display 141 is the self-luminous display, the upper substrate 141A of the display 141 may, for example, include a cover and a protection layer. When the display 141 is the non-self-luminous display, the upper substrate 141a of the display 141 may include, for example, a substrate, a color filter layer, and a transparent electrode. The maximum distance TH between the light exiting surface DS of the display 141 and the curved surface AS of the lens 142L may be, for example, in a range from 0.75 times the focal length to 1.25 times the focal length. The thickness adjusting layer 146 may be attached to the lens structure 142 by the adhesive layer 147, for example. The adhesive layer 147 may include, for example, optical adhesive, other suitable clear adhesives or a combination thereof. The thickness adjusting layer 146 may be, for example, a single layer or a multi-layer structure. The thickness adjusting layer 146 may include, for example, a circular polarizer, glass, optical adhesive, other suitable materials or a combination thereof. When the thickness adjusting layer 146 includes the multi-layer structure, the thickness adjusting layer 146 may include multiple layers of glass or other suitable transparent substrates, but not limited thereto.

For example, when the substrate 142F does not have polarizing property, the cover layer 143 may optionally include an anti-reflective film to reduce reflected light from the light exiting surface 14S of the display device 14, while the cover layer 143 or thickness adjusting layer 146 may optionally include a circular polarizer to reduce reflected light from transistors, signal lines, or other metal layers in the display 141. In some embodiments, when the substrate 142F has a polarizing property, the cover layer 143 may not include a circular polarizer, while the thickness adjusting layer 146 includes a circular polarizer and has an anti-reflective function. In this case, the cover layer 143 may optionally include the anti-reflective film.

In the embodiment of FIG. 2, the display device 14 may further include a heat spreading structure 148, and the display 141 is disposed on the heat spreading structure 148. For example, when the display 141 includes the light-emitting diodes, the heat spreading structure 148 may be used to reduce heat generated by driving the light-emitting diodes, thereby reducing possibility of damage to the display 141. The heat spreading structure 148 may be attached to a lower surface of the display 141 to facilitate heat dissipation. The heat spreading structure 148 may include, for example, heat sink, fan, water cooling system, heat pipe, or other suitable heat spreading structures. In some embodiments, when the display 141 is the non-self-luminous display, such as the LCD display, the display device 14 may not include the heat spreading structure 148, but not limited thereto.

In FIG. 2, the display device 14 may further include a sealant 149 used to attach the heat spreading structure 148 to a bottom of the thickness adjusting layer 146, and the display 141 is located between the heat spreading structure 148 and the thickness adjusting layer 146. In this case, air may exist between the display 141 and the thickness adjusting layer 146, but not limited thereto.

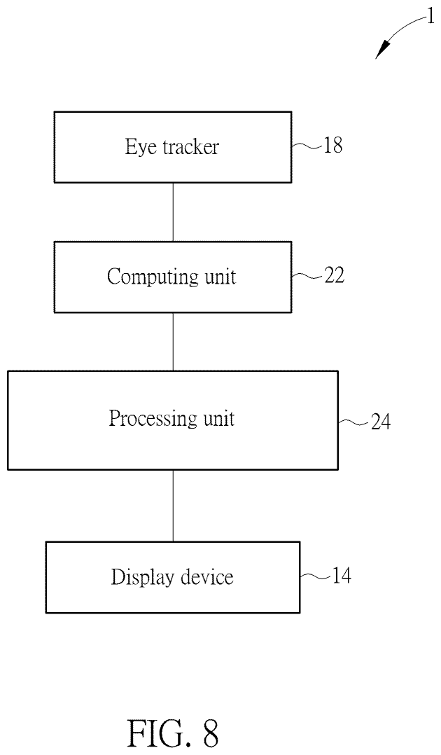

In some embodiments, the display device 14 may optionally further include an eye tracker (such as the eye tracker 18 in FIG. 8) to obtain information of the first position P1 corresponding to the left eye P1 and the second position P2 corresponding to the right eye, so that the display 141 is able to provide different image information according to the obtained position information. In some embodiments, a normal direction of a receiving surface of the eye tracker may be tilted towards the user at a certain angle, for example, tilted about 15 degrees upwards from the horizontal direction, such that receiving range of the eye tracker may cover the eyes of the user.

The detailed structure of the display device 14 of this embodiment will be further described below. Refer to FIG. 4 and FIG. 5. FIG. 4 schematically illustrates the light generated by the sub-pixel forming parallel light beams in the display device of the present disclosure, and FIG. 5 schematically illustrates a top view of the user viewing the image. As shown in FIG. 4, the lens structure 142 may have an exit angle difference θf. Specifically, since the light exiting surface DS of the display 141 is located in the equivalent focal plane of the lens structure 142, the light generated by a single sub-pixel SPX may form two light beams LB emitted in different directions after passing through two adjacent lenses 142L of the lens structure 142, that is, the propagating directions of the parallel light beams LB emitted from different lenses 142L are different from each other. The exit angle difference θf may be an angle between the propagating directions of the light beams LB emitted from the two adjacent lenses 142L. For example, when a single sub-pixel SPX is turned on and other sub-pixels SPX are turned off, light intensities of the display device are measured at different light exiting angles, and the exit angle difference θf is the difference between the light exiting angles corresponding to two adjacent peak light intensities. In some embodiments, the exit angle difference θf may also satisfy the following relation:

$$θ f = {tan}^{- 1} ( PH 2 / FL ) ,$$

where PH2 is the second pitch of the lenses 142L, and FL is the focal length of the lens 142L.

As shown in FIG. 5, there is an angle θ between a straight connection line (e.g., a single first beam L1) of a pixel point PPT in the first image IM1 and the first position P1 and a straight connection line LN4 between the pixel point PPT and the second position P2, and the angle θ satisfies a first relation:

$${tan}^{- 1} ( \frac{6}{P D + 15} ) \leq θ \leq {tan}^{- 1} ( \frac{7}{P D - 15} ) ,$$

where the unit of the projection distance PD is centimeter. The pixel point PPT in the first image IM1 may be formed, for example, by the light generated by a single sub-pixel SPX. For example, when the projection distance PD is in the range from 90 cm to 120 cm, the angle θ may be in the range from 2.545 degrees to 5.33 degrees. Alternatively, when the projection distance PD is about 100 cm, the angle θ may be in the range from 2.99 degrees to 4.711 degrees, or when the projection distance PD is about 105 cm, the angle θ may be in the range from 2.862 degrees to 4.449 degrees. The angle θ may be obtained, for example, by measurement.

In addition, to prevent the light generated by the same sub-pixel SPX (e.g., a single first beam L1) from being viewed by the left eye LE of the first position P1 and the right eye RE of the second position P2 at the same time, the angle θ satisfies a second relation:

$$θ \neq N \times θ f ,$$

where N is a positive integer. In other words, the first beams L1 used to form the first image IM1 are not directed to the second position P2, and the second beams L2 used to form the second image IM2 are not directed to the first position P1, such that both eyes are able to view the first image IM1 and the second image IM2 respectively, and the first image IM1 and the second image IM2 are not viewed by one eye at the same time. In FIG. 5, in order to clearly illustrate the first image IM1 and the second image IM2, the first image IM1 and the second image IM2 are separated, but not limited thereto. In some embodiments, the first image IM1 and the second image IM2 may be formed by different sub-pixel groups arranged alternately. Since the angle θ satisfies the first relation and second relation, the left eye LE is prevented from seeing the second image IM2 provided to the right eye RE, and the right eye RE is prevented from seeing the first image IM1 provided to the left eye LE.

In the embodiment of FIG. 5, the first image IM1 and the second image IM2 may be located on the projection plane PLa, and the first image IM1 and the second image IM2 presented at the projection plane PLa may be blurred images. In this case, the information of the first image IM1 and the second image IM2 may each be focused on the focus plane PLb, and the first image IM1 and the second image IM2 may be converged on a convergence plane PLC. In other words, the user may see a clear 3D image IM3 on the convergence plane PLC at about a distance ID from the first position P1 (or the second position P2), but not limited thereto. In some embodiments, the first image IM1 and the second image IM2 may also be converged on the focus plane PLb by controlling the display device, such that the convergence plane PLc coincides with the focus plane PLb. In some embodiments, the first image IM1 and the second image IM2 may be clear images, so that the focus plane PLb may coincide with the projection plane PLa. In this case, the user may view different images with different depths of field at the same time.

It should be noted that the display device further has a sub-pixel angle resolution, which refers to the angle between the propagating direction of the light beams formed by the light generated by two adjacent sub-pixels SPX corresponding to the same lens 142L after passing through the lens 142L. The sub-pixel angular resolution may, for example, be measured or calculated by the following relation:

$$Ar = θ f / ( PH 1 / PH 2 ) ,$$

where Ar is the sub-pixel angular resolution, PH1 is the first pitch (e.g., the first pitch PH1 as shown in FIG. 3) of the sub-pixels SPX, and PH2 is the second pitch (e.g., the second pitch PH2 as shown in FIG. 3) of the lenses 142L. Furthermore, in order to allow the user to clearly view the image converged on the focus plane PLb or on the convergence plane PLC, smaller sub-pixel angle resolution is better. For example, the sub-pixel angular resolution satisfies a third relation:

$$0.05 ° \leq Ar \times ( PD / 100 ) \leq 1 ° .$$

In the vehicle 1 of this embodiment, through the above relations, the display device 14 does not require complex and long optical path, so that the space for accommodating the display device 14 in the vehicle 1 may be reduced. In addition, by the measured projection distance PD, the sub-pixel angle resolution satisfying the third relation may be obtained, so that mismatch between depths of focus of the first image and the second image displayed by the display device 14 and the parallax of two eyes may be avoided or reduced, thereby improving user comfort or driving safety.

The other embodiments of this disclosure are described in detail below, and for simplicity of the description, the same component is marked with the same designation hereafter. In order to highlight the differences between the embodiments, the differences between the different embodiments are described in detail below, and the repeated technical features are not detailed. In addition, these repeated technical features are applicable to the following embodiments.

Refer to FIG. 6, which schematically illustrates cross-sectional view of a display device according to a variant embodiment of the first embodiment of the present disclosure. As shown in FIG. 6, the display device 14 of this embodiment differs from the display device 14 of FIG. 2 in that the intermediate layer 144 may include air. In this case, the cover layer 143 and the lens structure 142 may be fixed by an extra frame, but not limited thereto.

In the embodiment of FIG. 6, the display device 14 may not include the sealant 149, and the display 141 may be attached to the thickness adjusting layer 146 through an adhesive layer 1410. The adhesive layer 1410 may include, for example, optical adhesive, other suitable clear adhesives, or a combination thereof. In some embodiments, the display device 14 of FIG. 6 may include the sealant 149 as shown in FIG. 2 replacing the adhesive layer 1410. Other parts of the display device 14 of FIG. 6 may be identical or similar to the display device 14 of FIG. 2, so they are not repeated here, and the display device 14 of FIG. 6 may be applied to any of the above or following vehicles.

Refer to FIG. 7, which schematically illustrates a cross-sectional view of a vehicle according to a second embodiment of the present disclosure. As shown in FIG. 7, in the vehicle 1 of this embodiment, the light exiting surface 14S of the display device 14 is not parallel to the horizontal direction of the vehicle 1 (e.g., the direction X). The first position P1 is taken as an example of the position of the user, and the eyes have a vertical viewing angle γ downwards from the horizontal direction. It should be noted that in order to allow the user to easily view the image IM clearly, the eyes of the user may face the image IM directly when the eyes face down the vertical viewing angle γ. In this case, the light exiting surface 14S of the display device 14 may be combined with the tilt angle α of the windshield 12, such that the image IM may be projected to a position where the user is able to easily view it.

In the embodiment of FIG. 7, the windshield 12 has an intersection point PT4 with a horizontal line LN1 passing through the first position P1 and parallel to the horizontal direction, and a straight connection line LN2 of the first position P1 and a bottom edge of the image IM may have another intersection point PT5 with the windshield 12. The tilt angle α of the windshield 12 may be, for example, an angle between a straight connection line LN3 of the intersection point PT4 and the intersection point PT5 and the horizontal direction. There is an angle φ between the light exiting surface 14S of the display device 14 and the horizontal direction, and the angle φ may satisfy the following relation:

$$90 - 2 α + γ min < F < 90 - 2 α + γ max ,$$

where γmin is a minimum value of the vertical viewing angle γ, and γmax is a maximum value of the vertical viewing angle γ. The vertical viewing angle γ may be greater than 0 degrees and less than 10 degrees. In this case, the angle φ may be greater than (90−2α) degrees and less than (90−2α+10) degrees, but not limited thereto. Other parts of the vehicle 1 of FIG. 7 may be identical or similar to the vehicle of FIG. 1, so they are not repeated here, and the display device 14 of FIG. 7 may adopt the display device of any of the above embodiments.

Refer to FIG. 8, which schematically illustrates a block diagram of a system of a vehicle according to a third embodiment of the present disclosure. As shown in FIG. 8, the vehicle 1 of this embodiment may include an eye tracker 18, a computing unit 22, a processing unit 24, and a display device 14. The eye tracker 18 may be configured to obtain a first position information and a second position information, wherein the first position information and the second position information include a left eye coordinate and a right eye coordinate of the user, respectively. The first position information and the second position information may be, for example, the information of the first position P1 and the second position P2 shown in FIG. 2 or FIG. 5, respectively. The eye tracker 18 may obtain the first position information and the second position information, for example, by a detecting and calculating method or a lookup table method, but not limited thereto. The eye tracker 18 may include, for example, a driver monitoring system (DMS) or other suitable elements or systems. The computing unit 22 may be coupled to the eye tracker 18, for example, coupled in series with the eye tracker 18, so that the computing unit 22 may be used to receive first position information and second position information. Also, the computing unit 22 may generate a first image information and a second image information based on the first position information and the second position information. The computing unit 22 may be, for example, a central processing unit, an automotive computer, or other suitable units. For example, the first image information and the second image information may include navigation arrows, pedestrian warning signs, other suitable images, or a combination thereof. In some embodiments, the eye tracker 18 and the computing unit 22 may be integrated in the same device, for example, in the same AR glasses or other suitable vehicle.

In the embodiment of FIG. 8, the processing unit 24 is coupled between the computing unit 22 and the display device 14 and performs integrated calculations and processing based on the first image information, the second image information, the first position information, the second position information, and/or other images or position information to generate a display signal to be presented. For example, the processing unit 24 may further calculate a predetermined projection position and/or depth of field of the first image information and the second image information based on the first position information, the second position information and the predetermined presented image to obtain the projection distance of the first image information and the second image information (as shown in FIG. 1, the projection distance PD), but not limited thereto. The depths of field of the first image information and the second image information may include, for example, depth distributions of different navigation arrows or depths of signs. The processing unit 24 may be, for example, an image processing unit, such as a graphics processing unit (GPU), a field programmable gate array (FPGA), a central processing unit (CPU), other suitable elements, or a combination thereof. In some embodiments, the computing unit 22 may be included in the processing unit 24, but not limited thereto. The processing unit 24 may be a multiprocessor system on a chip (MPSoC), but not limited thereto.

In FIG. 8, the display device 14 may be coupled to the processing unit 24, and the processing unit 24 may transmit the display signal to the display device 14, such that the display device 14 generates the first image and the second image (e.g., the first image IM1 and the second image IM2 as shown in FIG. 5).

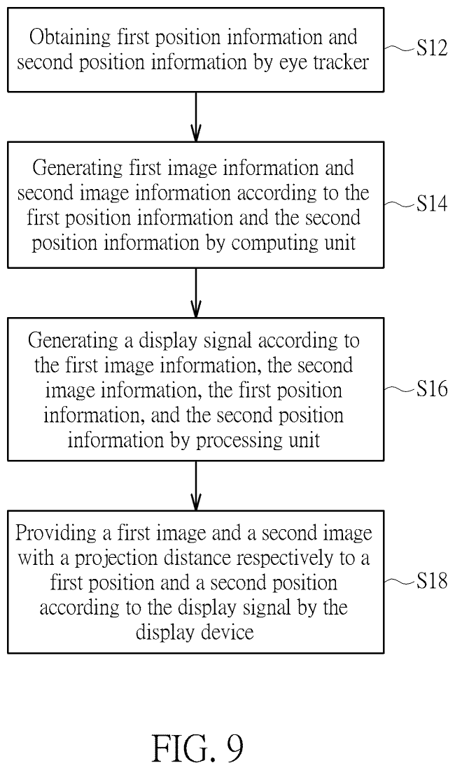

A driving method of the vehicle in this embodiment is further described below. Refer to FIG. 9 together with FIG. 8. FIG. 9 schematically illustrates a driving method of the vehicle according to the third embodiment of the present disclosure. As shown in FIG. 8 and FIG. 9, the driving method of the vehicle 1 in this embodiment includes step S12 to step S18. The driving method of the present disclosure may not be limited to the above steps, and other steps may be performed before, after, or during any of the above steps.

In step S12, the first position information and the second position information may be obtained by the eye tracker 18. Since the eye tracker 18 is able to detect the positions of the eyes of the user and/or movements of pupils of the eyes, the first position information and second position information corresponding to the eyes of the user may be obtained. The first position information and second position information may be, for example, relative position information of the eye tracker 18 and the eyes.

Then, in step S14, the first image information and the second image information may be generated by the computing unit 22 according to the first position information and the second position information, wherein the first image information corresponds to the first position information, and the second image information corresponds to the second position information. For example, the computing unit 22 may convert the predetermined presented image into the first image information corresponding to the left eye and the second image information corresponding to the right eye based on the first position information and the second position information. For example, a full arrow pattern may be converted into a part of the arrow pattern seen by the left eye and another part of the arrow pattern seen by the right eye. In other words, the computing unit 22 may adjust a part of the image corresponding to the left eye and another part of the image corresponding to the right eye according to device parameters in the display device 14 combined with the first position information and the second position information received. Therefore, as the interpupillary distance or the viewing position of the user is changed, the first image information and the second image information may be adjusted by the computing unit 22.

Then, in step S16, the display signal is generated by the processing unit 24 according to the first image information, the second image information, the first position information, and the second position information by the processing unit 24, and the display signal is transmitted to the display device 14. For example, the processing unit 24 may obtain the projection distance of the first image information and the second image information based on the first position information, the second position information, the first image information, and the second image information. The processing unit 24 may calculate the sum of the distance between the first position and the windshield (e.g., the distance D2 in FIG. 1) and the distance between the display device and the windshield (e.g., the distance D1 in FIG. 1) to obtain the projection distance based on the depth of focus of the predetermined image, first position information, and second position information. In other words, the display signal generated by the processing unit 24 may further include the depths of focus of the first image information and the second image information to be presented, but not limited thereto. In some embodiments, the processing unit 24 may have position information of the display device 14, so that the processing unit 24 may further generate the projection position of the first image information and the second image information (e.g., position information of the projection plane PLa of FIG. 5). In some embodiments, the processing unit 24 may further combine other information to generate a suitable display signal.

In step S18, after receiving the display signal, the first image and the second image with the projection distance may respectively be provided to the first position and second position by the display device 14. In other words, after receiving the first image information and the second image information, the display device 14 may generate light beams corresponding to the first image and the second image, thereby projecting the first image and the second image. It should be noted that with different positions of the users, the corresponding first position and the corresponding second position may be detected by the eye tracker 18 to obtain the corresponding projection distance. In addition, the display device 14 may focus the first image and the second image to the appropriate focus plane or convergence plane, thereby improving the viewing comfort of the user. For example, in a usage scenarios of the predetermined speedometer pattern being at 3 meters (m) and the predetermined arrow pattern being at 5 m, the left and right eye position information is obtained by the eye tracker 18, the left and right eye image information is generated by the computing unit 22, and the depth of focus in the display signal is adjusted by the processing unit 24, so that the speedometer pattern displayed to the left and right eyes by the display device 14 may be closer to the arrow pattern to improve the viewing comfort of the user.

In summary, in the vehicle of the present disclosure, the angle satisfying the first relation may be obtained through the given projection distance or the projection distance measured by the eye tracker, such that the first image and the second image displayed by the display device are respectively viewed by different eyes, thereby improving the comfort of the user and/or improving the driving safety. In addition, the display device formed by the above relations does not require the complex and long optical path, so that the space in the vehicle for accommodating the display device may be reduced.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A vehicle configured to provide a first image and a second image with a projection distance respectively to a first position and a second position, the vehicle comprising:
a windshield; and
a display device configured to generate a plurality of first light beams and a plurality of second light beams to be projected on a side of the windshield and to present the first image and the second image on another side of the windshield, the display device comprising:
a display comprising a plurality of first sub-pixels and a plurality of second sub-pixels; and
a lens structure disposed on the display and having an exit angle difference, wherein light generated by the plurality of first sub-pixels penetrates through the lens structure to form the plurality of first light beams, the plurality of first light beams form the first image, light generated by the plurality of second sub-pixels penetrates through the lens structure to form the plurality of second light beams, and the plurality of second light beams form the second image,
wherein an angle is between a connection line of a pixel point in the first image and the first position and another connection line of the pixel point in the first image and the second position, and the angle satisfies a first relation:
$${tan}^{- 1} ( \frac{6}{P D + 15} ) \leq θ \leq {tan}^{- 1} ( \frac{7}{P D - 15} ) ,$$
wherein θ is the angle, PD is the projection distance, and a unit of PD is centimeter,
wherein the angle satisfies a second relation:
θ≠N×θf,
wherein θf is the exit angle difference, and N is a positive integer.

2. The vehicle as claimed in claim 1, wherein when the projection distance is in a range from 90 centimeters to 120 centimeters, the angle is in a range from 2.545 degrees to 5.33 degrees.

3. The vehicle as claimed in claim 1, wherein the display device has a sub-pixel angular resolution, and the sub-pixel angular resolution satisfies a third relation:
$$0.05 ° \leq Ar \times ( PD / 100 ) \leq 1 ° ,$$
wherein Ar is the sub-pixel angular resolution.

4. The vehicle as claimed in claim 1, wherein the lens structure comprises a plurality of lenses extending along a direction, one of the plurality of first pixels has a long side and a short side, and another angle between an extending direction of the long side and the direction is in a range from 2 degrees to 20 degrees.

5. The vehicle as claimed in claim 1, wherein the display device further comprises a heat spreading structure, and the display is disposed on the heat spreading structure.

6. The vehicle as claimed in claim 1, wherein the display device further comprises a cover layer disposed on the lens structure.

7. The vehicle as claimed in claim 6, wherein the display device further comprises an intermediate layer disposed between the lens structure and the cover layer, the lens structure comprises a plurality of lenses, and a refractive index of the intermediate layer is less than a refractive index of one of the plurality of lenses.

8. The vehicle as claimed in claim 7, wherein the intermediate layer comprises glue or air.

9. The vehicle as claimed in claim 7, wherein the one of the plurality of lenses has a focal length, and a maximum distance between a curved surface of the one of plurality of lenses and a light exiting surface of the display is in a range from 0.75 times the focal length to 1.25 times the focal length.

10. The vehicle as claimed in claim 6, wherein the display device further comprises a thickness adjusting layer disposed between the display and the lens structure.

11. The vehicle as claimed in claim 10, wherein the lens structure does not have polarizing property, and the cover layer or the thickness adjusting layer comprises a circular polarizer.

12. The vehicle as claimed in claim 10, wherein the lens structure has a polarizing property, and the thickness adjusting layer comprises a circular polarizer.

13. The vehicle as claimed in claim 1, wherein the display device has a light exiting surface, and the light exiting surface is not parallel to a horizontal direction of the vehicle.

14. The vehicle as claimed in claim 1, wherein one of the plurality of first sub-pixels has a long side and a short side adjacent to the long side, an extending direction of the short side corresponds to a horizontal direction of the first image, an extending direction of the long side corresponds to a vertical direction of the first image, and a ratio of a length of the long side to a width of the short side is in a range from 4.5 to 30.

15. The vehicle as claimed in claim 1, wherein the lens structure comprises a plurality of lenses arranged on the display, light generated by one of the plurality of first sub-pixels penetrates through two of the plurality lenses to form two of the plurality of first light beams, and the exit angle difference is another angle between propagation directions of the two of the plurality of first light beams.

16. The vehicle as claimed in claim 1, further comprising an eye tracer configured to obtain information of the first position and the second position.

17. The vehicle as claimed in claim 1, wherein the projection distance is a shortest distance between the first position and the first image.

18. A driving method of a vehicle comprising a display device, an eye tracker, a computing unit, and a processing unit, and the driving method comprising:
obtaining first position information and second position information by the eye tracer, wherein the first position information and the second position information respectively comprise a left eye coordinate and a right eye coordinate of a user;
generating first image information and second image information according to the first position information and the second position information by the computing unit, wherein the first image information corresponds to the first position information, and the second image information corresponds to the second position information;
generating a display signal according to the first image information, the second image information, the first position information, and the second position information by the processing unit; and
providing a first image and a second image with a projection distance respectively to a first position and a second position according to the display signal by the display device.

19. The driving method as claimed in claim 18, further comprising obtaining the projection distance by the processing unit.

20. The driving method as claimed in claim 19, wherein the display signal comprises depths of focus of the first image information and the second image information.
